(19) United States
(12) Patent Application Publication
(10) Pub. No.: US 2010/0293352 A1
(43) Pub. Date: Nov. 18, 2010

(54) SEMICONDUCTOR MEMORY DEVICE

(75) Inventor: Yuji Nakaoka, , Kanagawa (JP)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LIQUID DESIGN SYSTEMS, INC., Kawasaki-shi, Kanagawa (JP)

(21) Appl. No.: 12/863,831

(22) PCT Filed: Jan. 19, 2009
(86) PCT No.: PCT/JP2009/050678

§ 371 Date: Jul. 21, 2010

(30) Foreign Application Priority Data
Jan. 22, 2008 (JP) 2008-011776

(51) Int. Cl. G06F 12/00

(52) U.S. Cl. 711/167; 711/E12.001

(57) ABSTRACT

The semiconductor memory device proposed in the present invention comprises the buffer control circuit which, when writing the data, controls the data input buffer so that the data from the same timing as the clock when the writing command is input is written in the activated memory bank, and which, when reading the data, controls the data output buffer so that the data with the read latency of more than 3 clock cycles after when the reading command is input is read from the activated memory bank.

### CROSS-REFERENCE TO RELATED APPLICATION

This application is the National Stage of International Application no. PCT/JP2009/050678 filed Jan. 19, 2009, which claims the benefit of Japanese patent application number 2008-011776 filed Jan. 22, 2008, the contents of which are incorporated by reference as if fully set forth herein.

### FIELD OF THE INVENTION

This invention is with respect to a semiconductor memory device.

### BACKGROUND

Conventionally, a memory device is proposed which comprises a plurality of memory banks and some of such banks are to be activated.

In Japanese Patent Laid-Open Publication No. 2000-163969 (FIG. 4, 5), “the operation to selectively activate the circuit 7 for the bank 0 and the circuit 8 for the bank 1 when the burst length BL=8” is described (paragraph 0047), and further, “generation of a block activation signal to activate either block in the circuit 7 for the bank 0” is described (paragraph 0040).

Also, in Japanese Patent Laid-Open Publication No. 2000-82287, it is described that “At the RAS generation unit 13, in response to this signal RASZ, either block in the circuit 5 for the bank 0 is activated, and concurrently, the sense amplifier 19 and the sense buffer 15 are also activated” (paragraph 0076).

### SUMMARY

Normally, with the technologies described in either of Japanese Laid-Open Publication No. 2000-163969 and Japanese Laid-Open Publication No. 2000-82287, each row address and column address is input via a common pin in order to reduce the number of pins. Therefore, it is impossible to designate completely random addresses. Also, an approach which utilizes general-purpose DRAMS to configure each bank requires changes in the timing design for writing and reading the data as the operational frequency of the DRAM device increases, which makes the timing design complicated

The present invention is proposed in order to resolve the said challenges and the objectives of the present invention are to reduce the manufacturing cost of a memory device as well as to provide a high-speed memory device whose random access capabilities are enhanced.

The semiconductor memory device proposed in the present invention comprises a plurality of memory banks that comprise a plurality of memory cells disposed in a row address direction and a column address direction, a row decoder that selects memory cells that correspond to a row address from among the plurality of memory cells, and a column decoder that selects memory cells that correspond to a column address from among the plurality of memory cells; a row address input means to which a row address to be provided to the row decoder is input; a column address input means to which a column address to be provided to the column decoder is input; an activation signal input means, provided for each of the memory banks, to which an activation signal to activate a memory bank is input; a data input means, provided commonly for the respective memory banks, for providing data input thereto to an activated memory bank among the plurality of the memory banks; a data output means, provided commonly for the respective memory banks, for outputting data read from the activated memory bank; and a control means for controlling, when data is written, the data input means such that data with the same timing as a clock when a writing command is input is written into the memory bank that is activated by the activation signal input to the activation signal input means, and for controlling, when data is read, the data output means such that with a predetermined read latency of equal to or more than 3 read latency with respect to a clock when a reading command is input, data is read from the memory bank that is activated by the activation signal input by the activation signal input means to output the data.

The present invention reduces the manufacturing cost of a memory device and provides a high-speed memory device whose random access capabilities are enhanced.

### BRIEF DESCRIPTION OF THE DRAWINGS

FIG. 1 is a view showing the configuration of the semiconductor memory device in which the present invention is implemented.

FIG. 2 is a view showing the detailed configuration of the data control circuit.

FIG. 3 is a view showing the detailed configuration of the memory cell array.

FIG. 4 is a timing chart to explain writing and reading of the data.

FIG. 5 is another timing chart to explain writing and reading of the data.

### DESCRIPTION OF PREFERRED EMBODIMENTS

The best exemplary embodiment of the present invention is explained as follows, referring to some figures.

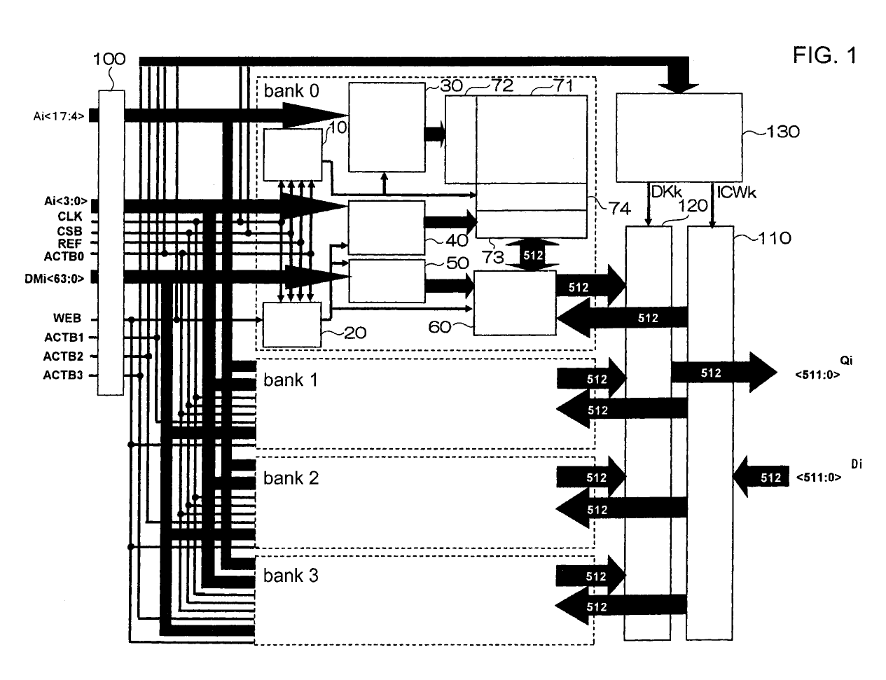

FIG. 1 is a view showing the configuration of the semiconductor memory device in which the present invention is implemented. The memory device comprises memory banks 0-3 which holds the data, the input buffer 100 in which addresses and commands are input, the data input buffer 110 in which the data to be written in the memory banks 0-3 is input, the data output buffer 120 to which the data read from memory banks 0-3 is output, and the buffer control circuit 130 which controls the data input by the data input buffer 110 and the data output by the data output buffer 120.

To the data input buffer 100, each of the 14 bit row address Ai (i=4-17), the 4 bit column address Ai (i=0-3), the clock CLK, the chip select signal CSB, the refresh signal REF, the 64 bit data mask signal DMi (i=0-63), the write enable signal WEB, the act commands ACTB0-ACTB3 are input.

The row address and the column address can be input concurrently via separate pins. The act commands ACTB0, ACTB1, ACTB2, and ACTB3 are the signals to activate each of the memory banks 0, 1, 2, and 3, and these signals are input via separate pins.

The data input buffer 110 provides input data Di (i=0-511) to either of the memory banks 0-3 based on the signal of the writing data capturing clock ICWk (k=0-3). In concrete, when the ICW0 is input, the data buffer 110 captures the input data Di and supplies it to the memory bank 0. Similarly, when the ICW1 is input, the data input buffer 110 supplies the input data Di to the memory bank 1, when the ICW2 is input, to the memory bank 2, and when the ICW3 is input, to the memory bank 0.

The data output buffer 120 outputs the 512 bit output data Doi (i=0-511) read either from the memory banks 0-3 based on the output data latch signal DKk (k=0-3). In concrete, when the DK0 is input, the data output buffer 120 outputs the data from the memory bank 0, when DK1 is input, outputs the data from the memory bank 2, and when DK3 is input, outputs the data from the memory bank 3.

The buffer control circuit 130 generates the signal of the data capturing clock ICWk (k=0-3) based on the Clock CLK, the chip select signal CSB, and the act commands ACTB0-ACTB3 supplied by the input buffer 110 when writing, and generates the output data latch signal DKk (k=0-3) when reading.

In this case, the ICWk represents the timing when the data input to the data input buffer 110 is captured. In concrete, the ICW0 is the signal to capture the data into the memory bank 0, the ICW1 is the signal to capture the data into the memory bank 1, the ICW2 is the signal to capture the data into the memory bank 2, and ICW3 is the signal to capture the data into the memory bank 3. Also, DKk represents the timing when the data is read from the memory bank k and is latched at the data output buffer 120.

The buffer control circuit 130, when writing, generates the ICWk at the same timing as the ACTBk clock when WEB/CBS is supplied and ACTBk is supplied. When reading, the buffer control circuit 130 generates DKk at the timing of three clock cycles after the ACTBk clock when CBS is supplied and ACTBk is supplied.

Each of the memory banks 0-3 has the same configuration. Here, the memory bank 0 comprises the row clock generator 10 which generates the row clock, the column address generator 20 which generates the column address, the row address buffer/refresh counter 30 which temporary stores the row address or which counts the number of refreshing, the column address buffer 40 which temporary stores the column address, and the data mask buffer 50 which temporary stores the data mask.

Further, the memory bank 0 comprises the memory cell array 71 which holds the data, the row decoder 72 which designates the row address, the column decoder 73 which designates the column address, the sense amplifier 74 which amplifies the voltage which is accumulated in the cell when reading the data, and the data control circuit 60 which writes or read the data to and from the memory cell array 71.

The row clock generator 10 generates the row clock to synchronize the row address based on the clock CLK, the chip select signal CSB, the refresh signal REF, and the act command ACTB0 provided by the input buffer 100, and supplies the row clock to the row address buffer/refresh counter 30 and the sense amplifier 74.

The column clock generator 20 generates the column clock to synchronize the column address based on the clock CLK, the chip select signal CSB, the refresh signal REF, and the act command ACTB0, and the write enable signal WEB provided by the input buffer 100, and supplies the column clock to the column address buffer 40, the data mask buffer 50, and the data control circuit 60.

The row address buffer/refresh counter 30 temporary stores the 14-bit row address Ai (i=4-17) supplied by the input buffer 100, synchronized with the row clock generated by the row clock generator 10, and supplies the row address to the row decoder 72. Also, the row address buffer/refresh counter 30 counts the number of refreshing of the memory cell array 71.

The column address buffer 40 temporary stores the 4-bit column address Ai (i=0-3) supplied by the input buffer 100, synchronized with the column clock generated by the column clock generator, and supplies the column address to the column decoder 73.

The data mask buffer 50 temporary stores the 64-bit data mask DMi (i=0-63) supplied by the input buffer 100, and supplies the data mask DMi to the data control circuit 60.

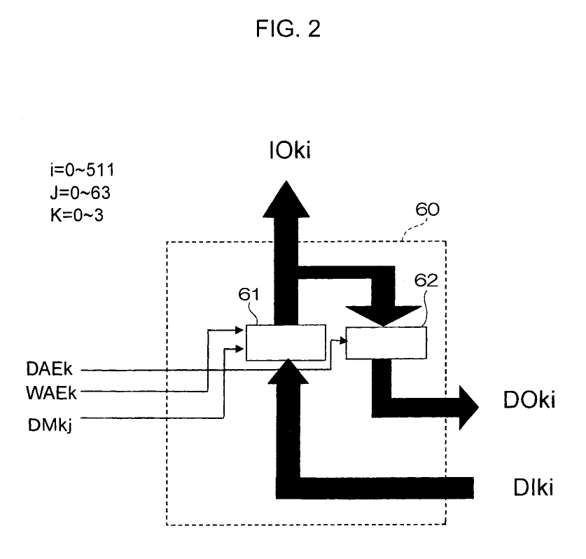

FIG. 2 shows the configuration of the data control circuit 60. The data control circuit 60 comprises the W amplifier 61 which supplies the input data to the memory cell array 71 and the D amplifier 62 which outputs the data read from the memory cell array 71.

The W amplifier 61 is activated when the W amplifier activation signal WAEk (k=0-3) is supplied or when the data mask DM is supplied from the data mask buffer 50. And the W amplifier 61 amplifies the 512-bit data DIKi (i=0-511) supplied by the data input buffer 110 and outputs the data IOKi to the global input and output line GIO of the memory cell array 71 which will be described later.

The D amplifier is activated when the DAMP activation signal DAEk (k=0-3) is supplied, amplifies the data read from the global input and output line GIO of the memory cell array 71 which will be described later, and outputs the data DOki to the data output buffer 120.

Also, the memory cell array 71 comprises a plurality of memory cells which are disposed in a matrix form. The row decoder 72 selects the row address. The column decoder 73 selects the column address. The sense amplifier 74 amplifies the voltage of the memory cell when reading the data.

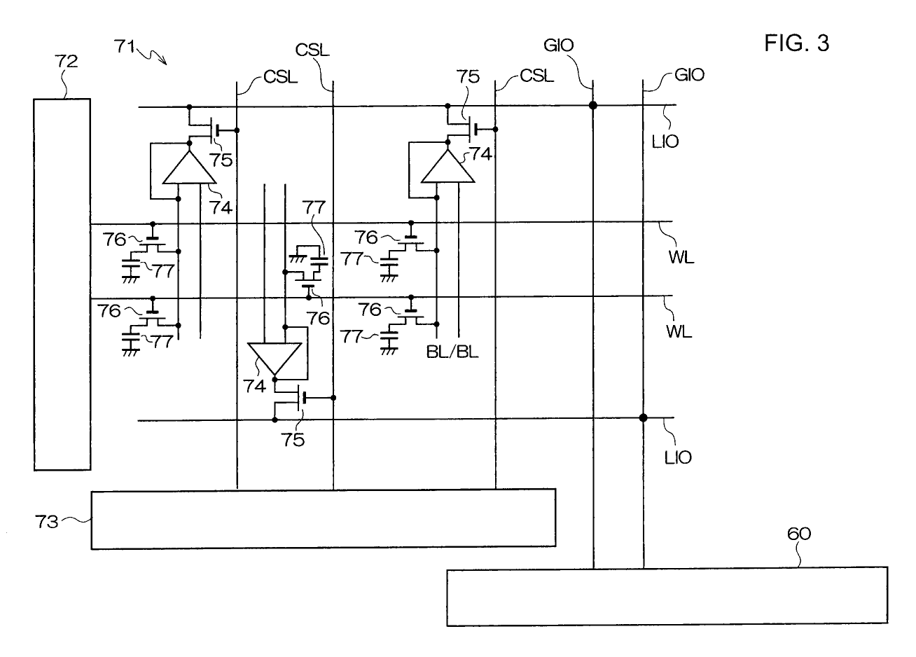

FIG. 3 shows the detailed configuration of the memory cell array 71. The memory cell array 71 comprises a plurality of word lines WL which are disposed in the row direction, a plurality of column selection lines CSL which are disposed in the column direction, the first FET 75 which is turned on when the voltage is supplied to the column line CSL, the second FET 76 which is turned on when the voltage is supplied to the word line WL, and the condenser 77 which corresponds with one memory cell, and the local input/output lines LIO and the global input/output line GIO to which the input or output data is supplied.

The drain of the first FET 75 is connected to the local input/output lines LIO and its source is connected to the output terminal of the sense amplifier 74 and its gate is connected to the column selection line CSL.

The sense amplifier 74 comprises the data input terminal BL to which the data is input, and the control terminal/BL to which the threshold signal to compare with the data is input, and the output terminal. The data input terminal and the output terminal are shorten. The sense amplifier 74 output a signal “1” when the input data is larger than the threshold signal and outputs “0” when the input data is smaller than the threshold signal via the output terminal.

The drain of the second FET 76 is connected to the data input terminal of the sense amplifier 74 and its gate is connected to the word line WL. One terminal of the condenser 77 is connected to the source of the second FET 76 and the other terminal is grounded.

When the row address is supplied from the row address buffer/refresh counter 30 shown in FIG. 1, the row decoder 72 outputs a signal to the word line WL which corresponds with the specific row address provided, and after a designated amount of time, stops the output of such signal. The row decoder 72 comprises internal delay elements to automatically reset the signal after outputting the signal so that it can operate only with an act command. Also, when the column address is supplied, the column decoder 73 provides a single column address selection signal to the column selection line CSL which corresponds with the specific column address provided.

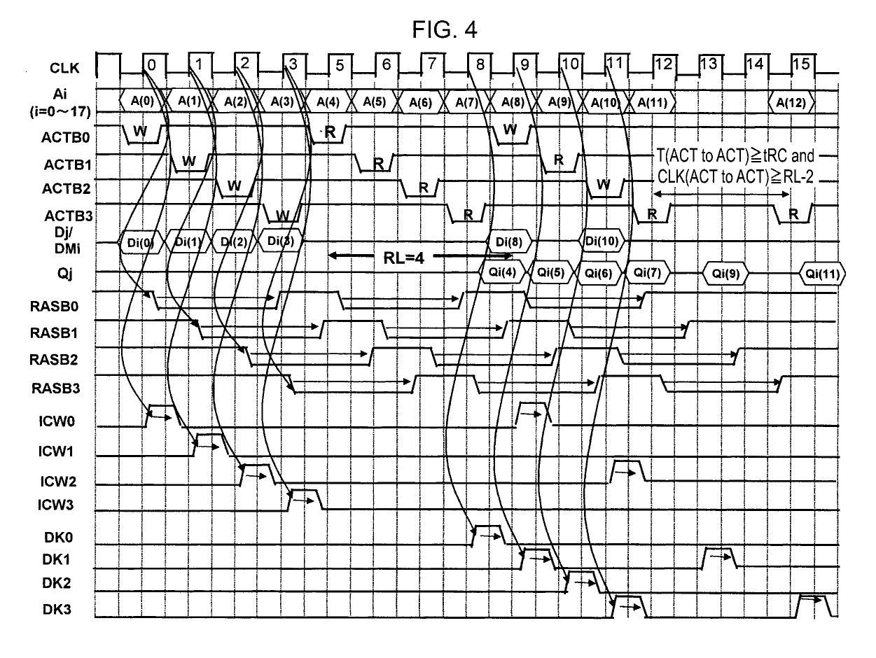

Thus, the semiconductor memory device with such configuration conducts writing and reading of the data in a timing explained as follows. FIG. 4 is a timing chart to explain writing and reading of the data.

Here are externally input data Ai (i=0-17), ACTB0-ACTB3, and Dj/DMi. Also, here is externally output data, Qj. Address Ai shows the column address and the row address. And address A(0), A(1), and A(2) . . . are input when the clock is 0, 1, and 2 . . . . The numbers in the brackets stand for corresponding numbers of clock.

Commands ACTB0, ACTB1, ACTB2, and ACTB3 activate each of the memory bank 0, 1, 2, and 3, and the commands exists for writing (W) and reading (R).

(Clock Timing 0-3)

When the clock timing is 0, 1, 2, and 3, the commands ACTB0, ACTB1, ACTB2, and ACTB3 for writing are input in the order, as well as the input data Di(0), Di(1), Di(2), and Di(3) are input in the order. In short, when the clock timing is 0-3, the writing commands for the memory bank 0-3 are input. By this, the following operations take place;

When the clock timing is 0, 1, 2, and 3, each of RASB0, RASB1, RASB2, and RASB3 falls in the order from a high level to a low level, and the writing data capturing clock signal ICW0, ICW1, ICW2, and ICW3 rise during only one clock cycle. After a designated period of time passes from the falling of RASB0, RASB1, RASB2, and RASB3, they then rise from a low level to a high level. As a result, when the clock timing is 0, 1, 2, and 3, the input data Di(0), Di(1), Di(2), and Di(3) are written on the memory cell array 71 in the corresponding memory bank 0-3.

(Clock Timing 4-7)

When the clock timing becomes 4, 5, 6, and 7, the commands ACTB0, ACTB1, ACTB2, and ACTB3 for reading are input in the order. In short, when the clock timing is 4-7, the reading commands for the memory bank 0-3 are input. By this, the following operations take place;

When the clock timing is 4, 5, 6, and 7, each of RASB0, RASB1, RASB2, and RASB3 falls in the order from a high level to a low level. And synchronizing with the clock timing 7, 8, 9, and 10, the output data latch signal DK0, DK1, DK2, and DK3 rise during only one clock cycle. And after 1 clock which is when the clock timing is 8, 9, 10, or 11, the output data Qi(4), Qi(5), Qi(6), and Qi(7) are read from the memory cell array 71 in the corresponding memory bank 0-3 each.

Here, the output data Qi(4), Qi(5), Qi(6), and Qi(7) are output at the timing of 4 clock cycles after the ACTB0, ACTB1, ACTB2, and ACTB3 as shown in FIG. 4. In other words, the read latency is set as RL=4.

(Clock Timing 8-11)

When the clock timing is 8, 9, 10, and 11, ACTB0 for writing, ACTB1 for reading, ACTB2 for writing, and ACTB3 for reading are input in the order, as well as the input data Di(8) at the clock timing 8 and the input data Di(10) at the clock timing 10 are input. In short, when the clock timing is 8-11, commands for writing the data to the memory bank 0, reading the data from the memory bank 1, writing the data to the memory bank 2, and reading the data from the memory bank 3 are input. By this, the following operations take place;

When the clock timing is 8, 9, 10, and 11, each of RASB0, RASB1, RASB2, and RASB3 falls in the order from a high level to a low level. And synchronizing with them, the ICW0 rises when the clock timing is 8, the ICW2 rises when the clock timing is 10, the DK1 rises when the clock timing is 12, and the DK3 rises when the clock timing is 14, during only one clock cycle. As a result, when the clock timing is 8 and 10, the input data Di (8) and Di(10) are written into the memory cell array 71 of the memory bank 0 and 2 each. Further, when the clock timing is 12 and 14, the output data Qi (9) and Qi(10) are read from the memory cell array 71 of the memory bank 1 and 3 each.

Here, the output data Qi(9) and Qi(10) are output 4 clock cycles after the ACTB1 and ACTB3 as shown in FIG. 4. In other words, the read latency is set as RL=4. Thus, even when writing and reading is conducted at every single clock cycle, writing and reading can be conducted with no gap.

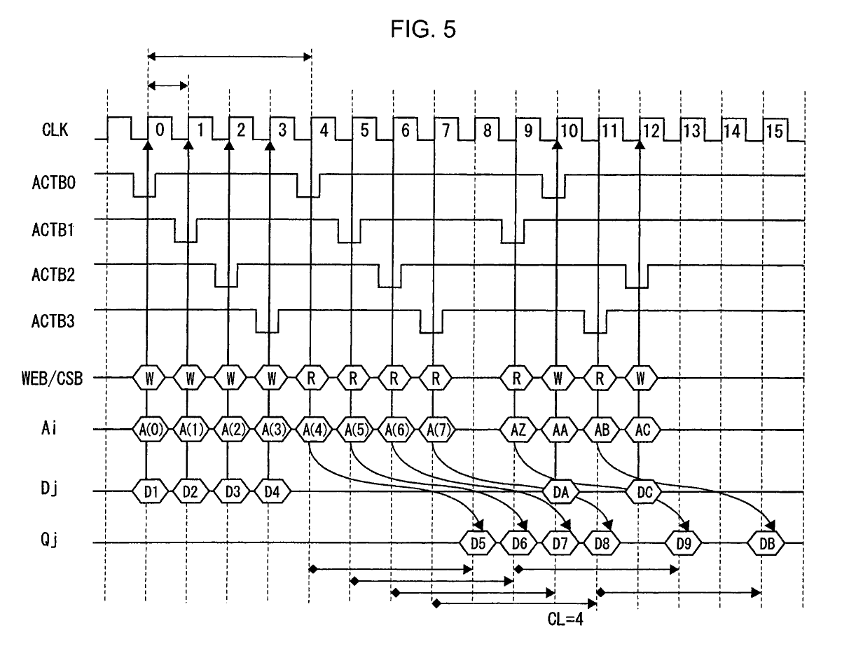

FIG. 5 is another timing chart which explains writing and reading of the data. Compared to FIG. 4, the timing for the write enable signal WEB/chip select signal CSB is added to FIG. 5. Also, when the clock timing is 8, there is no command either for reading or writing, but when the clock timing is 9-12, the WEB/CSB for reading, writing, reading, and writing are input in the order.

While FIG. 4 shows the example of when commands for writing, reading, writing, and reading are input in the order, even when the order of commands changes to reading, writing, reading, and writing, with the read latency remaining as RL=4, reading and writing can be conducted with now gap.

Thus, as previously explained, the semiconductor memory device with this exemplary embodiment of the present invention writes the data at the same timing when the commend signal is input for writing and reads the data after a designated period of latency from the clock when the command signal is input. By this, even when the frequency of the reading data increases, each memory bank can finish its internal operation during the clock cycles with the relevant latency, thus, the circuit can be designed with some extra timing.

Since the semiconductor memory device has means to input the row address and the column address independently, the row address and the column address can be input concurrently and a completely random address can be designated.

Also, the semiconductor memory device comprises a pin to input the ACTBi which activates each of the corresponding memory bank, as well as a common pin for each memory bank to deal with other signals and the ACTBi only activates one memory bank.

In order to activate memory banks one after another in a continuous manner, tRC (random cycle time) should be set with an interval, and the dummy clock of the read latency RL=2 should be input. Further, it is preferable that the conditions as follow are met as shown in FIG. 4;

T(ACT to ACT)≧tRC and

CLK(ACT to ACT)≧RL−2

In this case,

T(ACT to ACT): time between each of the continuing read command
tRC: Random cycle time
CLK(ACT to ACT): number of clocks between each of the continuing read command

Here, the method to access to the same memory bank and read the data one after another in a continuous manner is explained, but the present invention is not limited to this case. In other words, it is possible to access to the same single memory bank and read/write the data, or write/read the data. In such case, the conditions are as follow; T(ACT to ACT): time between the continuing read/write or write/read commands CLK(ACT to ACT): number of clocks between the continuing read/write or write/read commands.

Further, there is no need to increase the speed of each memory bank for the semiconductor memory device, which makes this method available for low cost DRAM processes. In short, it is possible to keep the manufacturing cost low. Also, if the number of memory banks is increased, the device can have an increased random access capability. Further, by changing the value of the read latency RL, the device can support various frequencies.

It is apparent that the present invention is not limited to the above embodiment, but may be modified and changed without departing from the scope and spirit of the invention. The exemplary embodiment has 4 memory banks as an example, but the number of memory banks is not limited to this particular number. The exemplary embodiment used read latency RL=4, but the value of RL can be any number equal to or larger than 3. Further, it is preferable that when the number of memory banks is n, the condition of 3≦RL≦n+1 is met. In this case, the timing to read the data of the row decoder 72 and the column decoder is changed, corresponding to the read latency RL, as well as the timing to generate the output data latch signal DKk (k=0-3) of the buffer control circuit 130 is changed, corresponding to the read latency RL. Also, the number of memory banks is not limited to 4 but can be any number equal to or larger than 3.

1. A semiconductor memory device, comprising:
a plurality of memory banks that respectively comprise a plurality of memory cells disposed in a row address direction and a column address direction, a row decoder that selects memory cells that correspond to a row address from among the plurality of memory cells, and a column decoder that selects memory cells that correspond to a column address from among the plurality of memory cells;
a row address input unit to which a row address to be provided to the row decoder is input;
a column address input unit to which a column address to be provided to the column decoder is input;
an activation signal input unit, provided for each of the memory banks, to which an activation signal to activate the respective memory bank is input;
a data input unit, provided commonly for the respective memory banks, that provides data input thereto to an activated memory bank among the plurality of the memory banks;
a data output unit, provided commonly for the respective memory banks, that outputs data read from the activated memory bank; and
a control unit that controls, when data is written, the data input unit such that data with the same timing as a clock when a writing command is input is written into the memory bank that is activated by the activation signal input to the activation signal input unit, and that controls, when data is read, the data output unit such that with a predetermined read latency of equal to or more than 3 read latency with respect to a clock when a reading command is input, data is read from the memory bank that is activated by the activation signal input by the activation signal input unit to output the data.

2. A semiconductor memory device according to claim 1, wherein the following condition is satisfied:
3≦RL≦n+1
, wherein n stands for a number of the banks, and RL stands for the read latency.

3. A semiconductor memory device according to claim 1, wherein the following conditions are satisfied when the same memory bank is accessed in a consecutive manner, if a time between any of the consecutive commands of reading/reading, reading/writing, writing/reading is defined as T(ACT to ACT), a random cycle time is defined as tRC, and a number of clocks between any of the consecutive commands of reading/reading, reading/writing, writing/reading is defined as CLK (ACT to ACT):
T(ACT to ACT)≧tRC and
CLK(ACT to ACT)≧RL−2,
wherein RL stands for the read latency.

4. A semiconductor memory device according to claim 2, wherein the following conditions are satisfied when the same memory bank is accessed in a consecutive manner, if a time between any of the consecutive commands of reading/reading, reading/writing, writing/reading is defined as T(ACT to ACT), a random cycle time is defined as tRC, and a number of clocks between any of the consecutive commands of reading/reading, reading/writing, writing/reading is defined as CLK (ACT to ACT):
T(ACT to ACT)≧tRC and
CLK(ACT to ACT)≧RL−2.
